(19) United States
(12) Patent Application Publication
(10) Pub. No.: US 2017/0369683 A1
(43) Pub. Date: Dec. 28, 2017

(54) Rubber Composition, And Pneumatic Tire And Conveyor Belt Each Produced Using Same

(71) Applicant: THE YOKOHAMA RUBBER CO., LTD., MINATO-KU, TOKYO (JP)

(72) Inventors: Manabu KATO, HIRATSUKA CITY, KANAGAWA (JP); Ryota TAKAHASHI, HIRATSUKA-CITY, KANAGAWA (JP); Takahiro OKAMATSU, HIRATSUKA-CITY, KANAGAWA (JP); Yoshiaki KIRINO, HIRATSUKA-CITY, KANAGAWA (JP)

(73) Assignee: THE YOKOHAMA RUBBER CO., LTD., MINATO-KU, TOKYO (JP)

(21) Appl. No.: 15/543,327

(22) PCT Filed: Jan. 18, 2016
(86) PCT No.: PCT/JP2016/051260

§ 371 Date: Jul. 13, 2017

(30) Foreign Application Priority Data
Jan. 19, 2015 (JP) 2015-007722

(51) Int. Cl. C08L 9/06; B60C 1/00

(52) U.S. Cl. CPC C08L 9/06; B60C 1/0016; C08L 2205/035; C08L 2205/02

(57) ABSTRACT

The present invention is to provide: a rubber composition which has excellent wet grip performance and wear resistance while maintaining the elongation thereof at a high level; and a pneumatic tire and a conveyer belt produced using the rubber composition. The present invention provides: a rubber composition containing a polymer containing from 10 to 90 mass % of a modified diene rubber having a carboxy group and an epoxy compound having a plurality of epoxy groups in each molecule, the content of the epoxy compound being from 0.1 to 5 parts by mass per 100 parts by mass of the polymer; and a pneumatic tire and a conveyor belt produced using the rubber composition.

### TECHNICAL FIELD

The present invention relates to a rubber composition, and a pneumatic tire and a conveyer belt produced using such a rubber composition.

### BACKGROUND ART

Conventionally, modified polymers modified with a nitrone compound have been proposed.

For example, Patent Document 1 proposes a modified polymer modified with two or more types of nitrones containing (A) a nitrone having at least one carboxy group and (B) a nitrone having no carboxy group.

### CITATION LIST

### Patent Literature

Patent Document 1: JP-A-2014-101400

### SUMMARY OF INVENTION

### Technical Problem

Recently, further enhancement in wet grip performance during travel of vehicles has been demanded for tires.

Furthermore, when the volume of a cap tread portion is reduced to reduce the weight of a tire, wear resistance of the cap tread portion needs to be enhanced.

In such circumstances, when the inventors of the present invention prepared a rubber composition according to Patent Document 1, it was found that wet grip performance and wear resistance thereof had room for improvement.

Furthermore, the inventors of the present invention found that, when a compound having a functional group that can react with a carboxy group is added to a polymer that is modified with nitrone and that has a carboxy group, at least one of elongation and wear resistance may become small. Therefore, it has been extremely difficult to enhance wear resistance while maintaining excellent elongation.

Therefore, an objective of the present invention is to provide a rubber composition which has excellent wet grip performance and also has excellent wear resistance while maintaining high elongation.

### Solution to Problem

As a result of diligent research to solve the problems described above, the inventors of the present invention found that predetermined effects were obtained by a rubber composition containing a polymer containing from 10 to 90 mass % of a modified diene rubber having a carboxy group and an epoxy compound having a plurality of epoxy groups in each molecule, the content of the epoxy compound being from 0.1 to 5 parts by mass per 100 parts by mass of the polymer, and thus completed the present invention.

The present invention is based on the findings described above and the like and, specifically, solves the problems described above by the following features.

1. A rubber composition containing:

a polymer containing from 10 to 90 mass % of a modified diene rubber having a carboxy group, and

an epoxy compound having a plurality of epoxy groups in each molecule;

a content of the epoxy compound being from 0.1 to 5 parts by mass per 100 parts by mass of the polymer.

2. The rubber composition according to 1 above, where a backbone of the modified diene rubber is at least one type selected from the group consisting of styrene butadiene rubbers, butadiene rubbers, and nitrile butadiene rubbers.

3. The rubber composition according to 1 or 2 above, where the modified diene rubber is produced by reacting a diene rubber as a raw material with a nitrone compound having a carboxy group and a nitrone group.

4. The rubber composition according to 3 above, where a degree of modification of double bonds into the carboxy groups relative to total amount of double bonds contained in the diene rubber as a raw material is from 0.02 to 4 mol %.

5. The rubber composition according 3 or 4 above, where the nitrone compound is at least one type of carboxy group-containing nitrone compound selected from the group consisting of

N-phenyl-α-(4-carboxyphenyl)nitrone,

N-phenyl-α-(3-carboxyphenyl)nitrone,

N-phenyl-α-(2-carboxyphenyl)nitrone,

N-(4-carboxyphenyl)-α-phenylnitrone,

N-(3-carboxyphenyl)-α-phenylnitrone, and

N-(2-carboxyphenyl)-α-phenylnitrone.

6. The rubber composition according to any one of 1 to 5 above, where a molecular weight of the epoxy compound is 3000 or less.

7. The rubber composition according to any one of 1 to 6 above, further containing a curing agent, the curing agent being an amine-based compound;

the amine-based compound having —NH₂ and at least one type of functional group selected from the group consisting of —NH₂, —NH—, and a carbon-nitrogen double bond, in each molecule.

8. The rubber composition according to 7 above, where a content of the curing agent is from 0.05 to 3.00 parts by mass per 100 parts by mass of the polymer.

9. The rubber composition according to any one of 1 to 8 above, where the polymer further contains a diene rubber.

10. A pneumatic tire comprising the rubber composition described in any one of 1 to 9 above.

11. A conveyor belt comprising the rubber composition described in any one of 1 to 9 above.

### Advantageous Effects of Invention

According to the present invention, a rubber composition which has excellent wet grip performance and also has excellent wear resistance while maintaining high elongation; and a pneumatic tire and a conveyer belt produced using the rubber composition can be provided.

### BRIEF DESCRIPTION OF DRAWING

FIG. 1 is a partial cross-sectional schematic view of a tire illustrating one embodiment of a pneumatic tire of the present invention.

### DESCRIPTION OF EMBODIMENTS

Embodiments of the present invention are described in detail below.

Note that, in the present specification, numerical ranges indicated using “(from) . . . to . . . ” include the former number as the lower limit value and the later number as the upper limit value.

Furthermore, in the present specification, when a component contains two or more types of substances, the content of the component indicates the total content of the two or more types of substances.

In the present specification, the case where even better effect(s) is achieved in at least one of wet grip performance, elongation, and wear resistance may be referred to as “(achieving) even better predetermined effects”.

### Rubber Composition

The rubber composition of the present invention is

a rubber composition containing:

a polymer containing from 10 to 90 mass % of a modified diene rubber having a carboxy group, and

an epoxy compound having a plurality of epoxy groups in each molecule;

the content of the epoxy compound being from 0.1 to 5 parts by mass per 100 parts by mass of the polymer.

It is conceived that predetermined effects can be achieved because the rubber composition of the present invention has the configuration described above. Although the reason for this is unknown, the reason is presumed to be as follows.

The rubber composition of the present invention contains an epoxy compound having a plurality of epoxy groups in each molecule, and the reaction of the plurality of epoxy groups contained in the one epoxy compound and the carboxy group contained in the modified diene rubber allows the formation of another crosslinking different from the crosslinking due to sulfur, and a larger number of crosslinking points can be formed compared to the case where the predetermined epoxy compound is not contained. In particular, when the number of the epoxy groups contained in each molecule of the epoxy compound is 3 or greater, three-dimensional mesh crosslinking can be formed.

The inventors of the present invention presume that such introduction of rubber into the crosslinking by the epoxy compound can toughen compound physical properties and increase the glass transition temperature of the rubber, thereby achieving predetermined effects.

Furthermore, the inventors of the present invention found that when the rubber composition contained an epoxy compound, setting resistance might deteriorate. The inventors of the present invention presume that the deterioration of setting resistance is due to unreacted epoxy compounds in the system.

Meanwhile, the inventors of the present invention found that when the rubber composition of the present invention further contained a curing agent, deterioration of setting resistance can be suppressed and, furthermore, toughening can be achieved.

The inventors of the present invention presume that the improvement of setting resistance is caused because even firmer crosslinked structure can be introduced into the rubber due to the reaction between the curing agent and the epoxy compound.

Each of the components contained in the rubber composition of the present invention will be described in detail below.

### Modified Diene Rubber

The modified diene rubber contained in the rubber composition of the present invention is a diene rubber that has a carboxy group and that has a backbone formed from a monomer containing at least a conjugated diene.

### Main Chain of Modified Diene Rubber

The conjugated diene that forms a main chain (backbone) of the modified diene rubber is not particularly limited. Examples thereof include conventionally known conjugated dienes. When the monomer contains a monomer other than the conjugated diene, the monomer is not particularly limited. Examples thereof include compounds having a vinyl-based functional group.

An example of a preferable aspect is one in which the modified diene rubber is a polymer that has a carboxy group and that has a diene rubber as a backbone.

The backbone of the modified diene rubber is not particularly limited as long as the backbone is a diene rubber. Specific examples of the diene rubber include a natural rubber (NR), an isoprene rubber (IR), a butadiene rubber (BR), an aromatic vinyl-conjugated diene copolymer rubber (e.g. styrene-butadiene rubber (SBR)), a nitrile butadiene rubber (NBR; acrylonitrile butadiene rubber), a butyl rubber (IIR), a halogenated butyl rubber (Br-IIR, Cl-IIR), and a chloroprene rubber (CR).

Among these, the backbone of the modified diene rubber is preferably at least one type selected from the group consisting of styrene butadiene rubbers, butadiene rubbers, and nitrile butadiene rubbers.

An example of a preferable aspect is one in which the modified diene rubber further has a double bond besides the carboxy group. The double bond may be located at the main chain, side chain, or terminal of the modified diene rubber.

### Carboxy Group

In the modified diene rubber, the carboxy group can bond to a main chain directly or via an organic group. Examples of the organic group having a carboxy group include groups represented by Formula (I-1) below and groups represented by Formula (I-2) below.

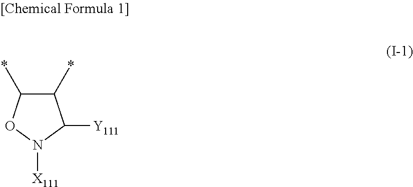

In Formula (I-1) above, X₁₁₁ and Y₁₁₁ each independently represent an aliphatic hydrocarbon group, an aromatic hydrocarbon group, an aromatic heterocycle group, or a combination of these, and X₁₁₁ and/or Y₁₁₁ is carboxy group(s). The carboxy group can bond to the aliphatic hydrocarbon group, the aromatic hydrocarbon group, the aromatic heterocycle group, or a combination of these.

The aliphatic hydrocarbon group, the aromatic hydrocarbon group, the aromatic heterocycle group, or combinations of these as X₁₁₁ or Y₁₁₁ are the same as the aliphatic hydrocarbon group, the aromatic hydrocarbon group, the aromatic heterocycle group, or combinations of these as X or Y of Formula (2) below.

An example of a preferable aspect is one in which X₁₁₁ and/or Y₁₁₁ is aromatic hydrocarbon group(s).

The number of the carboxy groups contained in the group represented by Formula (I-1) is 1 or greater, preferably from 1 to 4, and more preferably from 1 to 2.

In Formula (I-1), * indicates a bond position. In Formula (I-1), a .—CH—CH—. moiety can form a part of the main chain of the modified diene rubber.

Examples of the group represented by Formula (I-1) include groups represented by Formula (II) below.

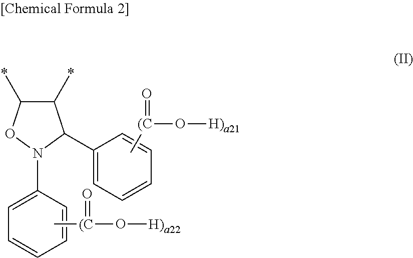

In Formula (II) above, a21 and a22 are each independently 0 or 1 or greater, and preferably from 1 to 5. a21+a22 is 1 or greater, preferably from 1 to 4, and more preferably from 1 to 2. * indicates a bond position. In Formula (II), a .—CH—CH—. moiety can form a part of the main chain of the modified diene rubber.

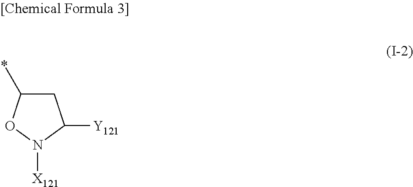

In Formula (I-2) above, X₁₂₁ and Y₁₂₁ each independently represent an aliphatic hydrocarbon group, an aromatic hydrocarbon group, an aromatic heterocycle group, or a combination of these, and X₁₂₁ and/or Y₁₂₁ can have carboxy group(s). The carboxy group can bond to an aliphatic hydrocarbon group, an aromatic hydrocarbon group, an aromatic heterocycle group, or a combination of these.

The aliphatic hydrocarbon group, the aromatic hydrocarbon group, the aromatic heterocycle group, and combinations of these as X₁₂₁ or Y₁₂₁ are the same as the aliphatic hydrocarbon group, the aromatic hydrocarbon group, the aromatic heterocycle group, or combinations of these as X or Y of Formula (2) below.

An example of a preferable aspect is one in which X₁₂₁ and/or Y₁₂₁ is aromatic hydrocarbon group(s).

The number of the carboxy groups contained in the group represented by Formula (I-2) is 1 or greater, preferably from 1 to 4, and more preferably from 1 to 2.

In Formula (I-2), * indicates a bond position. The group represented by Formula (I-2) can bond as a side chain or to a terminal of the modified diene rubber.

Examples of the group represented by Formula (I-2) include groups represented by Formula (III) below.

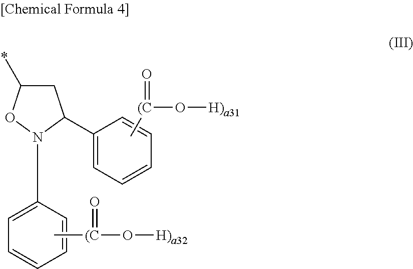

In Formula (III) above, a31 and a32 are each independently 0 or 1 or greater, and preferably from 1 to 5. a31+a32 is 1 or greater, preferably from 1 to 4, and more preferably from 1 to 2. * indicates a bond position. The group represented by Formula (III) can bond as a side chain or to a terminal of the modified diene rubber.

The amount of the carboxy group contained in the modified diene rubber relative to the total number of moles of the double bonds contained in the modified diene rubber and the carboxy groups contained in the modified diene rubber is preferably from 0.02 to 4 mol %, more preferably from 0.05 to 4 mol %, and even more preferably from 0.1 to 4 mol %.

The weight average molecular weight of the modified diene rubber is not particularly limited. For example, the weight average molecular weight may be from 100000 to 2000000, preferably from 200000 to 1500000, and more preferably from 300000 to 1300000. The weight average molecular weight (Mw) of the modified diene rubber is a value obtained by gel permeation chromatography (GPC) measured based on calibration with polystyrene standard using tetrahydrofuran as a solvent.

When the backbone of the modified diene rubber is an aromatic vinyl-conjugated diene copolymer rubber, the aromatic vinyl content of the modified diene rubber may be 10 mass % or greater, preferably from 26 to 80 mass %, and more preferably from 26 to 70 mass % in the modified diene rubber. The microstructure of modified diene rubber is measured in accordance with JIS K 6239:2007 (Rubber, raw, S-SBR Determination of the microstructure).

### Production Method of Modified Diene Rubber

For example, the modified diene rubber can be produced by reacting a diene rubber as a raw material with a nitrone compound having a carboxy group and a nitrone group.

In the reaction described above, the double bond contained in the diene rubber as a raw material can be modified into a carboxy group. Specifically, the double bond contained in the diene rubber and the nitrone group contained in the nitrone compound are reacted to form a five-membered ring having —O—N—, and a carboxy group is introduced into the diene rubber, thereby producing the modified diene rubber.

Specific examples of the method of producing the modified diene rubber include blending the diene rubber as a raw material and the nitrone compound at 100 to 200° C. for 1 to 30 minutes.

### Diene Rubber as Raw Material

The diene rubber as a raw material used in the production of the modified diene rubber is not particularly limited. Examples thereof include those exemplified for the backbone of the modified diene rubber.

Nitrone compound

The nitrone compound that can be used in the production of the modified diene rubber is a compound having a carboxy group and a nitrone group represented by Formula (1) below.

The number of the carboxy groups contained in each molecule of the nitrone compound is 1 or greater, and preferably from 1 to 4.

The number of the nitrone groups contained in each molecule of the nitrone compound is 1 or greater, and preferably from 1 to 4.

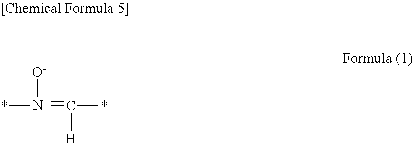 [SMILES: */C=[N+](/*)[O-]]

In Formula (1) above, * indicates a bond position.

The nitrone compound described above is preferably a compound represented by Formula (2) below.

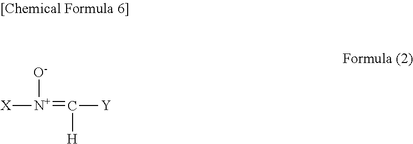

In Formula (2) above, X and Y each independently represent an aliphatic hydrocarbon group (including a straight chain, branched chain, and cyclic form), an aromatic hydrocarbon group, an aromatic heterocycle group, or a combination of these, and X and/or Y has carboxy group(s). The carboxy group can bond to an aliphatic hydrocarbon group, an aromatic hydrocarbon group, an aromatic heterocycle group, or a combination of these.

The number of the carboxy groups contained in each molecule of the compound represented by Formula (2) is 1 or greater, and preferably from 1 to 4.

Examples of the aliphatic hydrocarbon group represented by X or Y include alkyl groups, cycloalkyl groups, and alkenyl groups. Examples of the alkyl group include a methyl group, an ethyl group, an n-propyl group, an isopropyl group, an n-butyl group, an isobutyl group, a sec-butyl group, a tert-butyl group, an n-pentyl group, an isopentyl group, a neopentyl group, a tert-pentyl group, a 1-methylbutyl group, a 2-methylbutyl group, a 1,2-dimethylpropyl group, an n-hexyl group, an n-heptyl group, and an n-octyl group. Among these, alkyl groups having from 1 to 18 carbons are preferable, and alkyl groups having from 1 to 6 carbons are more preferable. Examples of the cycloalkyl group include a cyclopropyl group, a cyclobutyl group, a cyclopentyl group, and a cyclohexyl group. Among these, cycloalkyl groups having from 3 to 10 carbons are preferable, and cycloalkyl groups having from 3 to 6 carbons are more preferable. Examples of the alkenyl group include a vinyl group, a 1-propenyl group, an allyl group, an isopropenyl group, a 1-butenyl group, and a 2-butenyl group. Among these, alkenyl groups having from 2 to 18 carbons are preferable, and alkenyl groups having from 2 to 6 carbons are more preferable.

Examples of the aromatic hydrocarbon group represented by X or Y include aryl groups, and aralkyl groups.

Examples of the aryl group include a phenyl group, a naphthyl group, an anthryl group, a phenanthryl group, and a biphenyl group. Among these, aryl groups having from 6 to 14 carbons are preferable, aryl groups having from 6 to 10 carbons are more preferable, and a phenyl group and a naphthyl group are even more preferable.

Examples of the aralkyl group include a benzyl group, a phenethyl group, and a phenylpropyl group. Among these, aralkyl groups having from 7 to 13 carbons are preferable, aralkyl groups having from 7 to 11 carbons are more preferable, and a benzyl group is even more preferable.

Examples of the aromatic heterocycle group represented by X or Y include a pyrrolyl group, a furyl group, a thienyl group, a pyrazolyl group, an imidazolyl group (an imidazole group), an oxazolyl group, an isoxazolyl group, a thiazolyl group, an isothiazolyl group, a pyridyl group (a pyridine group), a furan group, a thiophene group, a pyridazinyl group, a pyrimidinyl group, and a pyrazinyl group. Among these, a pyridyl group is preferable.

The nitrone compound may contain a substituent other than the nitrone group and the carboxy group. Such a substituent is not particularly limited, and examples thereof include an alkyl group having from 1 to 4 carbons, a hydroxy group, an amino group, a nitro group, a sulfonyl group, an alkoxy group, and a halogen atom. Such a substituent can bond to at least one type selected from the group consisting of X and Y described above.

The nitrone compound is preferably a compound represented by Formula (3) below (carboxynitrone).

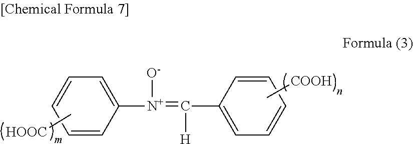

In Formula (3), m and n each independently represent an integer of 0 to 5, and the sum of m and n is 1 or greater.

The integer represented by m is preferably an integer of 0 to 2, and more preferably an integer of 0 or 1, because solubility in a solvent in nitrone compound synthesis becomes better, thereby making the synthesis easier.

The integer represented by n is preferably an integer of 0 to 2, and more preferably an integer of 0 or 1, because solubility in a solvent in nitrone compound synthesis becomes better, thereby making the synthesis easier.

Furthermore, the sum of m and n (m+n) is preferably from 1 to 4, and more preferably 1 or 2.

The compound represented by Formula (3) is preferably at least one type of carboxy group-containing nitrone compound selected from the group consisting of N-phenyl-α-(4-carboxyphenyl)nitrone represented by Formula (3-1) below, N-phenyl-α-(3-carboxyphenyl)nitrone represented by Formula (3-2) below, N-phenyl-α-(2-carboxyphenyl)nitrone represented by Formula (3-3) below, N-(4-carboxyphenyl)-α-phenylnitrone represented by Formula (3-4) below, N-(3-carboxyphenyl)-α-phenylnitrone represented by Formula (3-5) below, and N-(2-carboxyphenyl)-α-phenylnitrone represented by Formula (3-6) below.

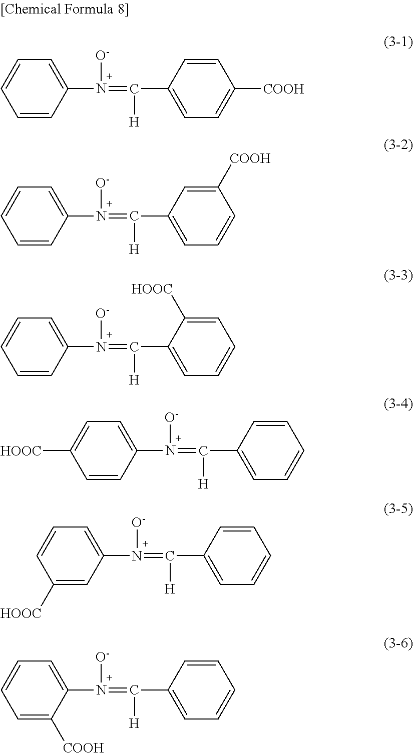

The method of synthesizing the nitrone compound is not particularly limited, and conventionally known methods can be used. For example, a nitrone compound having a nitrone group can be obtained by stirring a compound having a hydroxyamino group (—NHOH) and a compound having an aldehyde group (—CHO) at a molar ratio of hydroxyamino group to aldehyde group (—NHOH/—CHO) of 1.0 to 1.5 in the presence of an organic solvent (e.g. methanol, ethanol, and tetrahydrofuran) at room temperature for 1 to 24 hours to allow the both groups to react. The compound having a hydroxyamino group and/or the compound having an aldehyde group can have a carboxy group.

The used amount of the nitrone compound is preferably from 0.1 to 10 parts by mass, and more preferably from 0.2 to 5 parts by mass, per 100 parts by mass of the diene rubber as a raw material.

The degree of modification of double bonds into the carboxy groups relative to the total amount of double bonds contained in the diene rubber as a raw material (carboxy group/total amount of double bonds contained in a raw material diene rubber; hereinafter, this is also referred to as “degree of modification of double bonds”) is preferably from 0.02 to 4 mol % (in this case, from 0.02 to 4 mol % of the total amount of double bonds contained in the diene rubber is modified into a carboxy group with the nitrone compound), more preferably from 0.05 to 4 mol %, and even more preferably from 0.1 to 4 mol %.

When the diene rubber as a raw material is modified with the nitrone compound, the degree of modification of double bonds into the carboxy group of the nitrone compound relative to the total amount of double bonds contained in the diene rubber as a raw material is preferably from 0.02 to 4 mol %, more preferably from 0.05 to 4 mol %, and even more preferably from 0.1 to 4 mol %.

The degree of modification can represent the proportion (mol %) of double bonds that have been modified into carboxy groups by the modification due to, for example, the nitrone compound among all double bonds contained in the raw material diene rubber. The degree of modification can be determined, for example, by performing NMR (nuclear magnetic resonance spectroscopy) analysis on the raw material diene rubber and the modified diene rubber (i.e. diene rubber before and after the modification).

The content of the nitrone compound contained in the modified diene rubber is preferably from 0.1 to 10 parts by mass, and more preferably from 0.2 to 5 parts by mass, per 100 parts by mass of the diene rubber as a raw material.

The content of the nitrone compound contained in the modified diene rubber is preferably from 0.01 to 10 parts by mass, and more preferably from 0.05 to 5 parts by mass, per 100 parts by mass of the polymer containing the modified diene rubber in the predetermined amount.

The modified diene rubber may contain an unreacted modifying agent (e.g. nitrone compound).

A single modified diene rubber can be used or a combination of two or more types of modified diene rubbers can be used.

### Polymer

In the present invention, the polymer contains the modified diene rubber and a polymer other than the modified diene rubber.

An example of a preferable aspect is one in which such a polymer other than the modified diene rubber contained in the polymer includes a diene rubber. Examples of the diene rubber include those exemplified for the backbone of the modified diene rubber.

Among these, the diene rubber other than the modified diene rubber is preferably all or at least one type selected from the group consisting of the natural rubbers, styrene butadiene rubbers, and butadiene rubbers.

The polymer contained in the rubber composition of the present invention contains from 10 to 90 mass % of the modified diene rubber. The content of the modified diene rubber is preferably from 15 to 80 mass %, and more preferably from 20 to 70 mass %, relative to the amount of the polymer from the perspective of achieving even better predetermined effects and excellent handleability during processing.

### Epoxy Compound

The epoxy compound contained in the rubber composition of the present invention is a compound having a plurality of epoxy groups in each molecule.

The epoxy group can bond to a hydrocarbon group that may have a substituent.

The hydrocarbon group is not particularly limited. Examples thereof include aliphatic hydrocarbon groups (that may be in any of straight chain, branched, or cyclic form), aromatic hydrocarbon groups, and combinations thereof. The hydrocarbon group may have an unsaturated bond.

The number of the epoxy groups contained in each molecule of the epoxy compound is preferably from 2 to 6, and more preferably from 2 to 4, from the perspective of achieving predetermined effects even better.

Examples of the epoxy compound include epoxy resins, such as bisphenol A-type epoxy resins, diaminodiphenylmethane-type epoxy resins, and dicyclopentadiene-type epoxy resins.

The molecular weight of the epoxy compound is preferably 3000 or less, and more preferably from 400 to 700. Note that, when the epoxy compound is a polymer, the molecular weight of the epoxy compound may be a number average molecular weight. In the present invention, the number average molecular weight of the epoxy compound is a value obtained by gel permeation chromatography (GPC) measured based on calibration with polystyrene standard using tetrahydrofuran (THF) as a solvent.

A single epoxy compound may be used alone or a combination of two or more types of the epoxy compounds may be used.

In the present invention, the content of the epoxy compound is from 0.1 to 5 parts by mass per 100 parts by mass of the polymer (polymer containing a predetermined amount of the modified diene rubber, the polymer being contained in the rubber composition of the present invention; hereinafter the same). The content of the epoxy compound is preferably from 0.3 to 5 parts by mass, and more preferably from 0.5 to 3 parts by mass, per 100 parts by mass of the polymer from the perspective of achieving predetermined effects even better.

In the present invention, the molar ratio of the epoxy group contained in the epoxy compound to the carboxy group contained in the modified diene rubber (epoxy group/carboxy group) is preferably from 1.5 to 18. When the molar ratio is within this range, even better wet grip performance is achieved as the molar ratio of epoxy group/carboxy group becomes greater.

The molar ratio of epoxy group/carboxy group is more preferably from 6 to 15, and even more preferably from 10 to 14.

The rubber composition of the present invention may further contain additives within a scope that does not inhibit the effect or purpose thereof. Examples of the additive include silica, carbon black, silane coupling agents (e.g. Si69, manufactured by Evonic Degussa, and Si363, manufactured by Evonic Degussa), zinc oxide (flower of zinc), stearic acid, anti-aging agents, processing aids, waxes, oils, liquid polymers, terpene resins, thermosetting resins, vulcanizing agents (e.g. sulfur), vulcanization accelerators, and curing agents.

### Curing Agent

The rubber composition of the present invention preferably further contains a curing agent.

By allowing the rubber composition of the present invention to further contain a curing agent, even better predetermined effects and excellent setting resistance can be achieved.

An example of a preferable aspect is one in which the curing agent is a compound having two or more functional groups that can react with epoxy groups. The curing agent may react with a carboxy group contained in the modified diene rubber.

Examples of the functional group include amine-based functional groups, such as an amino group (—NH₂), —NH—, and —N═C< (carbon-nitrogen double bond); a hydroxy group; and a carboxy group. Among these, an amine-based functional group is preferable. Note that, when the curing agent contains a carboxy group as the functional group, the curing agent containing the carboxy group as the functional group contains no modified diene rubber described above.

### Amine-Based Compound

The amine-based compound that can be further contained in the rubber composition of the present invention as the curing agent is a compound having two or more amine-based functional groups. The amine-based functional groups are the same as those described above.

The number of the amine-based functional groups contained in one molecule of the amine-based compound is preferably from 2 to 10.

The amine-based functional groups can bond to hydrocarbon groups that may have a hetero atom.

The hydrocarbon group is not particularly limited. Examples thereof include aliphatic hydrocarbon groups (that may be in any of straight chain, branched, or cyclic form), aromatic hydrocarbon groups, and combinations thereof. The hydrocarbon group may have an unsaturated bond.

Examples of the hetero atom include an oxygen atom, a nitrogen atom, a sulfur atom, halogens, and combinations of these. Examples of the group formed by the combination of hetero atoms include a sulfonyl group, an ester bond, a urethane bond, and a urea bond.

An example of a preferable aspect is one in which the amine-based compound has —NH₂ (first —NH₂) and at least one type of functional group selected from the group consisting of —NH₂ (second —NH₂), —NH—, and a carbon-nitrogen double bond, in each molecule.

Examples of the amine-based compound include a compound I having at least a first —NH₂ and a second —NH₂ as the functional group in each molecule; and

a compound II having a first —NH₂ and at least one type of functional group selected from the group consisting of —NH— and a carbon-nitrogen double bond in each molecule.

### Compound I

The compound I is a compound having at least a first —NH₂ and a second —NH₂ as the functional group in each molecule.

The compound I is preferably a polyamine compound having two or more —NH₂.

In the compound I, an example of a preferable aspect is one in which —NH₂ bonds to an aromatic hydrocarbon group.

An example of a preferable aspect is one in which the compound I has two aromatic hydrocarbon groups to which —NH₂ moieties are bonded, and the aromatic hydrocarbon groups bond via a sulfonyl group.

Examples of the compound I include aromatic polyamines. Specific examples thereof include diaminodiphenylsulfone (DDS), diaminodiphenylmethane, and phenylenediamine.

Among these, diaminodiphenylsulfone is preferable.

### Compound II

The compound II is a compound having a first —NH₂ and at least one type of functional group selected from the group consisting of —NH— and a carbon-nitrogen double bond in each molecule.

To the nitrogen atom of the carbon-nitrogen double bond (N═C), for example, a hydrogen atom can be bonded.

The compound II can further contain a cyano group.

Examples of the compound II include dicyandiamide.

The production of the curing agent is not particularly limited. A single curing agent can be used or a combination of two or more curing agents can be used.

The content of the curing agent is preferably from 0.05 to 3.00 parts by mass, and more preferably from 0.20 to 1.50 parts by mass, per 100 parts by mass of the polymer.

The mass ratio of the epoxy compound to the curing agent (epoxy compound/curing agent) is preferably from 0.5 to 3, and more preferably from 1 to 2, from the perspective of achieving superior enhancement of setting resistance.

### Silica

The rubber composition of the present invention preferably further contains a silica.

The silica is not particularly limited, and any conventionally known silica that is blended in rubber compositions for use in tires or the like can be used.

Specific examples of the silica include wet silica, dry silica, fumed silica, and diatomaceous earth. One type of the silica may be used alone, or two or more types of the silicas may be used in combination.

The silica is preferably wet silica from the perspective of reinforcing property of rubber.

The content of the silica is not particularly limited but is preferably from 20 to 130 parts by mass, and more preferably from 25 to 95 parts by mass, per 100 parts by mass of the polymer (polymer containing a predetermined amount of the modified diene rubber, the polymer being contained in the rubber composition of the present invention).

### Carbon Black

The rubber composition of the present invention preferably further contains a carbon black.

The carbon black is not particularly limited and examples thereof include carbon blacks of various grades, such as SAF-HS, SAF, ISAF-HS, ISAF, ISAF-LS, IISAF-HS, HAF-HS, HAF, HAF-LS, and FEF.

The content of the carbon black is not particularly limited, but is preferably from 1 to 100 parts by mass, and more preferably from 3 to 60 parts by mass, per 100 parts by mass of the polymer described above.

### Method of Producing Rubber Composition

The method of producing the rubber composition of the present invention is not particularly limited, and specific examples thereof include a method whereby each of the above-mentioned components is kneaded using a publicly known method and device (e.g. Banbury mixer, kneader, and roller). When the rubber composition of the present invention contains sulfur or a vulcanization accelerator, the components other than the sulfur and the vulcanization accelerator are preferably blended first, for example, in a condition of 60 to 160° C. to obtain a mixture. Thereafter, the mixture is preferably cooled, and the sulfur and the vulcanization accelerator are then preferably added to the mixture and mixed.

In addition, the rubber composition of the present invention can be vulcanized or crosslinked under conventionally known vulcanizing or crosslinking conditions.

### Pneumatic Tire

The pneumatic tire of the present invention is a pneumatic tire produced using the rubber composition of the present invention described above. In particular, the pneumatic tire is preferably a pneumatic tire produced using the rubber composition of the present invention in a tire tread.

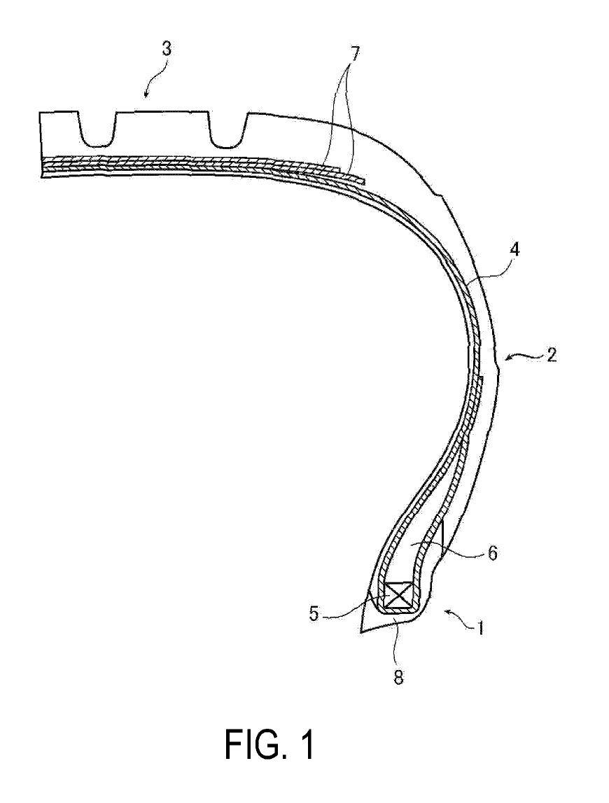

FIG. 1 is a partial cross-sectional schematic view of a tire that represents one embodiment of the pneumatic tire of the present invention, but the pneumatic tire of the present invention is not limited to the aspect illustrated in FIG. 1.

In FIG. 1, reference sign 1 denotes a bead portion, reference sign 2 denotes a sidewall portion, and reference sign 3 denotes a tire tread portion.

In addition, a carcass layer 4, in which a fiber cord is embedded, is mounted between a left-right pair of bead portions 1, and ends of the carcass layer 4 are wound by being folded around bead cores 5 and a bead filler 6 from an inner side to an outer side of the tire.

In the tire tread portion 3, belt layers 7 are provided along the entire circumference of the tire on the outer side of the carcass layer 4.

Additionally, rim cushions 8 are provided in parts of the bead portions 1 that are in contact with a rim.

The pneumatic tire of the present invention can be produced, for example, in accordance with conventionally known methods. In addition to ordinary air or air with an adjusted oxygen partial pressure, inert gases such as nitrogen, argon, and helium can be used as the gas with which the tire is filled.

### Conveyor Belt

The conveyor belt of the present invention is a conveyor belt produced using the rubber composition of the present invention described above.

Examples of the conveyor belt of the present invention include a conveyor belt having at least a cover rubber layer and a reinforcing layer. The cover rubber layer may be separated into an upper cover rubber layer and a lower cover rubber layer. In this case, for example, a reinforcing layer may be arranged in between the upper cover rubber layer and the lower cover rubber layer.

The rubber composition of the present invention can be used in at least one type selected from the group consisting of a cover rubber layer and a reinforcing layer.

The conveyor belt of the present invention is not particularly limited as long as the conveyor belt includes the rubber composition of the present invention.

Examples of the method of producing the conveyor belt of the present invention include conventionally known methods.

Articles that can be transported by the conveyor belt of the present invention are not particularly limited.

### EXAMPLES

The present invention is described below in detail using examples but, the present invention is not limited to such examples.

### Synthesis of Nitrone Compound 1

In a 2 L eggplant-shaped flask, methanol heated to 40° C. (900 mL) was charged, and then terephthalaldehydic acid represented by Formula (b-1) below (30.0 g) was added and dissolved. To this solution, a solution in which phenylhydroxylamine represented by Formula (a-1) below (21.8 g) was dissolved in methanol (100 mL) was added and stirred at room temperature for 19 hours. After the completion of stirring, a nitrone compound (carboxynitrone, CPN) represented by Formula (c-1) below (41.7 g) was obtained by recrystallization from methanol. The yield was 86%. The obtained nitrone compound was used as the nitrone compound 1. The molecular weight of the nitrone compound 1 was 241.

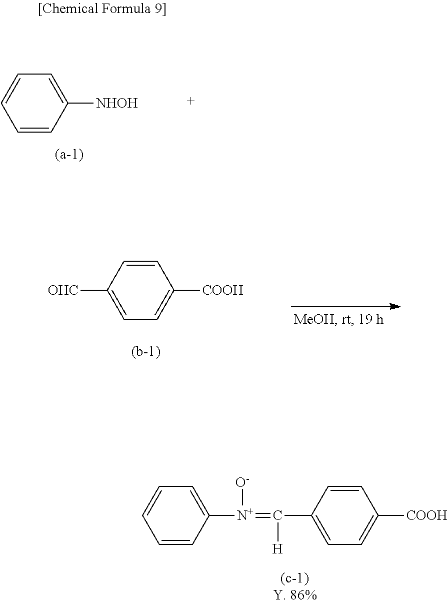

### Synthesis of Nitrone Compound 2

In a 300 mL eggplant-shaped flask, benzaldehyde represented by Formula (6) below (42.45 g) and ethanol (10 mL) were charged, and then a solution in which phenylhydroxylamine represented by Formula (5) below (43.65 g) was dissolved in ethanol (70 mL) was added thereto and stirred at room temperature for 22 hours. After the completion of stirring, diphenylnitrone represented by formula (7) below (65.40 g) was obtained as white crystal by recrystallization from ethanol. The yield was 83%. The obtained nitrone compound was used as the nitrone compound 2.

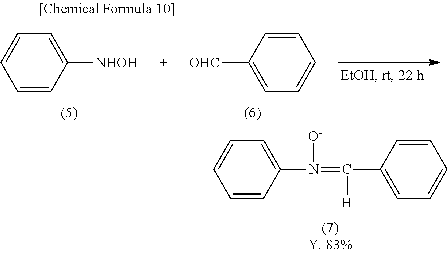

### Production of Modified Diene Rubber 1

A modified diene rubber 1 in which the SBR was modified with the nitrone compound 1 was obtained by mixing 137.5 parts by mass of styrene butadiene rubber (E580; styrene content: 37 mass %; weight average molecular weight: 800000; manufactured by Asahi Kasei Chemicals Corporation; oil extended product; oil extender content relative to the net amount of the styrene butadiene rubber: 37.5 mass %) and the nitrone compound 1 (0.85 parts by mass) for 5 minutes using a mixer (160° C.) in a condition at 160° C.

With the nitrone compound 1, 0.18 mol % of the double bonds contained in the SBR were modified into carboxy groups (degree of modification of double bond: 0.18 mol %).

The modification efficiency of the used nitrone compound 1 was 80%.

The degree of modification (0.18 mol %) was determined as described below.

### Degree of Modification of Modified Diene Rubber 1

The modified diene rubber 1 obtained as described above was subjected to NMR analysis to determine the degree of modification. Specifically, in the cases in which nitrone compound 1 produced as described above was used, the polymers before and after modification (the diene rubber as a raw material and the modified diene rubber) were measured for the peak area (derived from two protons adjacent to the carboxy group) at around 8.08 ppm via ¹H-NMR (CDCl₃, 400 MHz; reference material TMS: tetramethylsilane) using CDCl₃ as a solvent to find the degree of modification.

Note that the ¹H-NMR analysis of the modified diene rubber was performed by using a sample obtained as follows: the product after the modification was dissolved in toluene, purified by methanol precipitation twice, and then dried under reduced pressure.

### Production of Modified Diene Rubber 2

The modified diene rubber 2 in which the SBR was modified with the nitrone compound 2 was produced in the same manner as for the modified polymer 1 except for using the nitrone compound 2 in place of the nitrone compound 1. With the nitrone compound 2, 0.22 mol % of the double bonds contained in the SBR were modified. The modified diene rubber 2 contained no carboxy groups. The degree of modification (0.22 mol %) was determined as described below.

### Degree of Modification of Modified Diene Rubber 2

Using a differential scanning calorimetry (DSC; DSC823e, manufactured by Mettler Toledo), the glass transition temperatures (unit: ° C.) were measured by heating the modified diene rubber 2 and the diene rubber used as the raw material at rates of temperature increase of 10° C./min from −130° C. to 40° C.

The present inventors have found that a proportional relation exists between a degree of modification of a modified diene rubber (unit: mol %) and a rate of change of glass transition temperature (Tg). Based on this finding, the degree of modification (mol %) of the modified diene rubber 2 was determined by the following equation.

Degree of modification=ΔTg/3.6

In the formula, ΔTg is determined as follows. ΔTg=Tg of modified diene rubber−Tg of diene rubber used as raw material

### Preparation of Rubber Composition

A rubber composition was produced by blending the components shown in Tables 1-1, 1-2, and 1-3 below in the amounts (part by mass) shown in the same tables. Specifically, the components shown in Tables 1-1, 1-2, and 1-3 below except for sulfur and vulcanization accelerators were first mixed in a Banbury mixer at 80° C. for 5 minutes to obtain a mixture. Thereafter, the sulfur and the vulcanization accelerator were added and mixed to the mixture using a roll to obtain a rubber composition.

Also for Table 3, a rubber composition was produced in the same manner as in Tables 1-1, 1-2, and 1-3.

The modified diene rubber 1 used in Tables 1-1, 1-2, and 1-3 contained the net amount of 35.6 parts by mass of the modified diene rubber 1. The net amount of 35.6 parts by mass of the modified diene rubber 1 contains 0.3 parts by mass of the nitrone compound 1. These are the same in Table 3.

Furthermore, in the comparative examples, when the modified diene rubber 2 containing no carboxy group is used, or when the epoxy compound was not used, “-” was denoted in the rows of “epoxy group/carboxy group” of Tables 1-1, 1-2, and 1-3 since the epoxy group/carboxy group cannot be calculated.

The epoxy group/carboxy group refers to a molar ratio of the epoxy group contained in the epoxy compound to the carboxy group contained in the modified diene rubber.

### Production of Vulcanized Rubber Sheet

A vulcanized rubber sheet was produced by press-vulcanizing the (unvulcanized) rubber composition prepared as described above for 20 minutes at 160° C. in a mold (15 cm×15 cm×0.2 cm).

### Evaluation

The following evaluations were performed using the vulcanized rubber sheet produced as described above. The results are shown in Tables 1-1, 1-2, and 1-3 and Table 3. Note that the results of setting resistance are shown in Table 3. Each of the evaluation results was shown as an index value, with the result of Comparative Example 1 expressed as an index value of 100.

### Elongation (Elongation at Break)

In the present invention, elongation was evaluated by elongation at break.

A No. 3 dumbbell-shaped test piece was punched out of the vulcanized rubber sheet produced as described above, and tensile test was conducted using the test piece in accordance with JIS K6251 at a tensile rate of 500 mm/minute. The elongation at break (E_{B}) was measured at room temperature.

A larger index value indicates superior elongation at break.

### Wear Resistance

For the vulcanized rubber sheet produced as described above, abrasion loss was measured in accordance with JIS K6264-1,2:2005 using a Lambourn abrasion tester (manufactured by Iwamoto Seisakusho) at a temperature of 20° C. and at a slip rate of 50%.

Note that evaluation result of the wear resistance was shown as an index value which was a reciprocal of the amount of wear of each example, with the reciprocal of the amount of wear of Comparative Example 1 expressed as an index value of 100. A larger index value indicates a smaller amount of wear and thus excellent wear resistance when a tire is formed.

Wet grip performance: tan δ (0° C.)

The loss tangent at a temperature of 0° C., tan δ (0° C.), was measured for the vulcanized rubber sheet produced as described above using a viscoelastic spectrometer (manufactured by Toyo Seiki Seisaku-sho, Ltd.) under the following conditions: 10% initial distortion, ±2% amplitude, and 20 Hz frequency.

A larger index value indicates a larger value of tan δ (0° C.) and evaluated as having superior wet grip performance.

### Setting Resistance

For the vulcanized rubber sheet obtained as described above, the amount of strain was measured after load in a condition at 70° C. for 22 hours in an initial distortion of 25% was removed in accordance with JIS K6262.

Note that evaluation result of the setting resistance was shown as an index value which was a reciprocal of the amount of strain after the load was removed of each example, with the reciprocal of the result of Comparative Example 1 expressed as an index value of 100.

A larger index value indicates superior setting resistance (properties by which the rubber is difficult to be permanently deformed even when subjected to compressive deformation).

TABLE 1

| | Comparative | Comparative | Comparative | Comparative | Comparative |
|---|---|---|---|---|---|
| | Example 1 | Example 2 | Example 3 | Example 4 | Example 5 |
| Component | Formulation (part by mass) | | | | |
| NR | 16.00 | 16.00 | 16.00 | 16.00 | 16.00 |
| SBR | 98.00 | 98.00 | 98.00 | 98.00 | 49.00 |
| BR | 13.00 | 13.00 | 13.00 | 13.00 | 13.00 |
| Modified diene rubber 1 | | | | | 49.00 |
| Modified diene rubber 2 | | | | | |
| (for comparison) | | | | | |
| Carbon black | 20.00 | 20.00 | 20.00 | 20.00 | 20.00 |
| Silica | 60.00 | 60.00 | 60.00 | 60.00 | 60.00 |
| Stearic acid | 2.00 | 2.00 | 2.00 | 2.00 | 2.00 |
| Processing aid | 2.00 | 2.00 | 2.00 | 2.00 | 2.00 |
| Anti-aging agent | 3.00 | 3.00 | 3.00 | 3.00 | 3.00 |
| Wax | 1.00 | 1.00 | 1.00 | 1.00 | 1.00 |
| Coupling agent | 4.80 | 4.80 | 4.80 | 4.80 | 4.80 |
| Oil | 16.17 | 16.17 | 16.17 | 16.17 | 16.17 |
| Zinc oxide | 3.00 | 3.00 | 3.00 | 3.00 | 3.00 |
| Sulfur | 1.85 | 1.85 | 1.85 | 1.85 | 1.85 |
| Vulcanization | 2.30 | 2.30 | 2.30 | 2.30 | 2.30 |
| accelerater (CZ) | | | | | |
| Vulcanization | 0.65 | 0.65 | 0.65 | 0.65 | 0.65 |
| accelerater (DPG) | | | | | |
| Epoxy compound 1 | | 3.00 | | | |
| Epoxy compound 2 | | | 1.20 | | |
| Epoxy compound 3 | | | | 1.20 | |
| Epoxy compound 4 | | | | | |
| Epoxy group/carboxy | — | — | — | — | — |
| group (molar ratio) | | | | | |
| Elongation | 100 | 104 | 106 | 97 | 102 |
| Wear resistance | 100 | 99 | 97 | 99 | 103 |
| Wet grip performance | 100 | 104 | 106 | 104 | 93 |

TABLE 2

| | Example 1 | Example 2 | Example 3 | Example 4 |
|---|---|---|---|---|
| Component | Formulation (part by mass) | | | |
| NR | 16.00 | 16.00 | 16.00 | 16.00 |
| SBR | 49.00 | 49.00 | 49.00 | 49.00 |
| BR | 13.00 | 13.00 | 13.00 | 13.00 |
| Modified diene rubber 1 | 49.00 | 49.00 | 49.00 | 49.00 |
| Modified diene rubber 2 | | | | |
| (for comparison) | | | | |
| Carbon black | 20.00 | 20.00 | 20.00 | 20.00 |
| Silica | 60.00 | 60.00 | 60.00 | 60.00 |
| Stearic acid | 2.00 | 2.00 | 2.00 | 2.00 |
| Processing aid | 2.00 | 2.00 | 2.00 | 2.00 |
| Anti-aging agent | 3.00 | 3.00 | 3.00 | 3.00 |
| Wax | 1.00 | 1.00 | 1.00 | 1.00 |
| Coupling agent | 4.80 | 4.80 | 4.80 | 4.80 |
| Oil | 16.17 | 16.17 | 16.17 | 16.17 |
| Zinc oxide | 3.00 | 3.00 | 3.00 | 3.00 |
| Sulfur | 1.85 | 1.85 | 1.85 | 1.85 |
| Vulcanization | 2.30 | 2.30 | 2.30 | 2.30 |
| accelerator (CZ) | | | | |
| Vulcanization | 0.65 | 0.65 | 0.65 | 0.65 |
| accelerator (DPG) | | | | |
| Epoxy compound 1 | 1.20 | 3.00 | | |
| Epoxy compound 2 | | | 1.20 | |
| Epoxy compound 3 | | | | 1.20 |
| Epoxy compound 4 | | | | |
| Epoxy group/carboxy | 4 | 10 | 12 | 5 |
| group (molar ratio) | | | | |
| Elongation | 105 | 100 | 101 | 103 |
| Wear resistance | 125 | 143 | 135 | 138 |
| Wet grip performance | 108 | 109 | 114 | 108 |

TABLE 3

| | Comparative | Comparative | Comparative | Comparative | Comparative |
|---|---|---|---|---|---|
| | Example 6 | Example 7 | Example 8 | Example 9 | Example 10 |
| Component | Formulation (part by mass) | | | | |
| NR | 16.00 | 16.00 | 16.00 | 16.00 | 16.00 |
| SBR | 49.00 | 49.00 | 49.00 | 49.00 | 49.00 |
| BR | 13.00 | 13.00 | 13.00 | 13.00 | 13.00 |
| Modified diene rubber 1 | 49.00 | 49.00 | 49.00 | | 49.00 |
| Modified diene rubber 2 | | | | 49.00 | |
| (for comparison) | | | | | |
| Carbon black | 20.00 | 20.00 | 20.00 | 20.00 | 20.00 |
| Silica | 60.00 | 60.00 | 60.00 | 60.00 | 60.00 |
| Stearic acid | 2.00 | 2.00 | 2.00 | 2.00 | 2.00 |
| Processing aid | 2.00 | 2.00 | 2.00 | 2.00 | 2.00 |
| Anti-aging agent | 3.00 | 3.00 | 3.00 | 3.00 | 3.00 |
| Wax | 1.00 | 1.00 | 1.00 | 1.00 | 1.00 |
| Coupling agent | 4.80 | 4.80 | 4.80 | 4.80 | 4.80 |
| Oil | 16.17 | 16.17 | 16.17 | 16.17 | 16.17 |
| Zinc oxide | 3.00 | 3.00 | 3.00 | 3.00 | 3.00 |
| Sulfur | 1.85 | 1.85 | 1.85 | 1.85 | 1.85 |
| Vulcanization | 2.30 | 2.30 | 2.30 | 2.30 | 2.30 |
| accelerator (CZ) | | | | | |
| Vulcanization | 0.65 | 0.65 | 0.65 | 0.65 | 0.65 |
| accelerator (DPG) | | | | | |
| Epoxy compound 1 | 6.00 | | | 1.20 | |
| Epoxy compound 2 | | 6.00 | | | |
| Epoxy compound 3 | | | 6.00 | | |
| Epoxy compound 4 | | | | | 1.20 |
| Epoxy group/carboxy | 19 | 60 | 25 | — | 5 |
| group (molar ratio) | | | | | |
| Elongation | 95 | 88 | 83 | 98 | 96 |
| Wear resistance | 110 | 92 | 94 | 102 | 104 |
| Wet grip performance | 107 | 102 | 109 | 99 | 104 |

Details of the components listed in Tables 1-1, 1-2, and 1-3 are as follows.

TABLE 4

| | | Compound |
|---|---|---|
| Component | Manufacturer | name/product name |
| NR | NATURAL RUBBER | Natural rubber, |
| | | TSR20 |
| SBR | ASAHI KASEI | Styrene butadiene |
| | CHEMICALS | rubber, E581, |
| | CORPORATION | solution- |
| | | polymerized SBR (St |
| | | 37%, Vi 43%, 37.5 |
| | | phr oil extension) |
| BR | Zeon Corporation | Butadiene rubber, |
| | | Nipol BR 1220 |
| Modified diene | Material produced | — |
| rubber 1 | as described above | |
| Modified diene | Material produced | — |
| rubber 2 | as described above | |
| (for comparison) | | |
| Carbon black | Tokai Carbon Co., | SEAST 9M |
| | Ltd. | |
| Silica | Rhodia Silica | ZEOSIL 165GR |
| | Korea, Co., Ltd. | |
| Stearic acid | NOF Corporation | Stearic acid YR |
| Processing aid | Rhein Chemie | Aktiplast ST |
| | (Qingdao) Ltd. | |
| Anti-aging agent | Soltia Europe | SANTOFLEX 6PPD |
| Wax | Ouchi Shinko | SANNOC |
| | Chemical Industrial | |
| | Co., Ltd. | |
| Coupling agent | Evonik Degussa | Si69 |
| Oil | Showa Shell Sekiyu | Extract No. 4S |
| | K.K. | |
| Zinc oxide | Seido Chemical | Zinc Oxide III |
| | Industry Co., Ltd. | |
| Sulfur | Karuizawa Refinery | Oil treatment |
| | Ltd. | sulfur |
| Vulcanization | Ouchi Shinko | NOCCELER CZ-G |
| accelerator (CZ) | Chemical Industrial | |
| | Co., Ltd. | |
| Vulcanization | Sumitomo Chemical | Soxinol D-G |
| accelerator (DPG) | Co., Ltd. | |
| Epoxy | Nippon Steel | EpotohtoYD-128 |
| compound 1 | Chemical Co., Ltd. | (bifunctional; |
| | | molecular weight: |
| | | 628) bisphenol A- |
| | | type epoxy resins |
| Epoxy | Sumitomo Chemical | ELM 434 |
| compound 2 | Co., Ltd. | (tetrafunctional; |
| | | molecular weight: |
| | | 402), |
| | | diaminodiphenyl- |
| | | methane-type epoxy |
| | | resin |
| Epoxy | DIC Corporation | Hp 7200 |
| compound 3 | | (trifunctional; |
| | | molecular weight: |
| | | 712), |
| | | dicyclopentadiene- |
| | | type epoxy resin |
| Epoxy | Sanko Co., Ltd. | OPP-G |
| compound 4 | | (monofunctional; |
| | | molecular weight: |
| | | 226), glycidyl |
| | | ether-type epoxy |
| | | resin |

As is clear from the results shown in Table 1, Comparative Examples 2 to 4, which contained no predetermined modified diene rubber, exhibited inferior wear resistances compared to that of Comparative Example 1. Furthermore, Comparative Example 4 resulted in lower elongation than that of Comparative Example 1.

Comparative Example 5, which contained no epoxy compound, exhibited inferior wet grip performance compared to that of Comparative Example 1.

Comparative Examples 6 to 8, in which the content of the epoxy compound was not within the predetermined range, exhibited, at least, inferior elongations compared to that of Comparative Example 1. Comparative Examples 7 and 8 exhibited inferior wear resistances compared to that of Comparative Example 1.

Comparative Example 9, which contained a modified diene rubber containing no carboxy group in place of the predetermined modified diene rubber, did not maintain high elongation, needed further enhancement in wear resistance, and deteriorated the wet grip performance compared to those of Comparative Example 1.

Comparative Example 10, which contained a monofunctional epoxy compound in place of the predetermined epoxy compound, did not maintain high elongation and needed further enhancement in wear resistance compared to those of Comparative Example 1.

On the other hand, Examples 1 to 4 exhibited superior wet grip performances and wear resistances while maintaining high elongations.

Furthermore, when Examples 1, 4, and 3 are compared, it was found that the case where a large number of epoxy groups was contained in each molecule of epoxy compound exhibited superior wet grip performance. Furthermore, it was found that, when the number of the epoxy groups contained in each molecule of epoxy compound was three, even better wear resistance was exhibited.

When Examples 1 and 2 are compared, it was found that the case where the epoxy compound content was greater exhibited even better wear resistance and wet grip performance.

When Examples 1 to 4 are compared, the case where the molar ratio of epoxy group/carboxy group was greater exhibited even better wet grip performance. Furthermore, it was found that, since Example 2 had even better wear resistance than those of Examples 1, 3, and 4, when the molar ratio of epoxy group/carboxy group was from 6 to 11, Example 2 exhibited even better wear resistance.

TABLE 5

| | Comparative | Exam- | Exam- | Exam- |
|---|---|---|---|---|
| | Example 1 | ple 5 | ple 6 | ple 7 |
| Component | Formulation (part by mass) | | | |
| NR | 16.00 | 16.00 | 16.00 | 16.00 |
| SBR | 98.00 | 49.00 | 49.00 | 49.00 |
| BR | 13.00 | 13.00 | 13.00 | 13.00 |
| Modified diene rubber 1 | | 49.00 | 49.00 | 49.00 |
| Carbon black | 20.00 | 20.00 | 20.00 | 20.00 |
| Silica | 60.00 | 60.00 | 60.00 | 60.00 |
| Stearic acid | 2.00 | 2.00 | 2.00 | 2.00 |
| Processing aid | 2.00 | 2.00 | 2.00 | 2.00 |
| Anti-aging agent | 3.00 | 3.00 | 3.00 | 3.00 |
| Wax | 1.00 | 1.00 | 1.00 | 1.00 |
| Coupling agent | 4.80 | 4.80 | 4.80 | 4.80 |
| Oil | 16.17 | 16.17 | 16.17 | 16.17 |
| Zinc oxide | 3.00 | 3.00 | 3.00 | 3.00 |
| Sulfur | 1.85 | 1.85 | 1.85 | 1.85 |
| Vulcanization | 2.30 | 2.30 | 2.30 | 2.30 |
| accelerator (CZ) | | | | |
| Vulcanization | 0.65 | 0.65 | 0.65 | 0.65 |
| accelerator (DPG) | | | | |
| Epoxy compound 2 | | 1.27 | 1.27 | 1.90 |
| Curing agent 1 | | | 0.70 | 1.40 |
| Epoxy group/carboxy | | 10 | 10 | 15 |
| group (molar ratio) | | | | |
| Epoxy group/(carboxy | | | 1.9 | 1.3 |
| group of modified diene | | | | |
| rubber + group of curing | | | | |
| agent) (molar ratio) | | | | |
| Elongation | 100 | 104 | 104 | 106 |
| Wear resistance | 100 | 110 | 122 | 138 |
| Setting resistance | 100 | 93 | 109 | 108 |
| Wet grip performance | 100 | 107 | 112 | 116 |

The details of the components used in Table 3 are the same as those described in Table 2 except the curing agent 1. The details of the curing agent 1 are as follows.

Curing agent 1: 4,4′-diaminodiphenylsulfone (4,4′-DDS), manufactured by Wakayama Seika Kogyo Co., Ltd.

As is clear from the results shown in Table 3, Example 5 exhibited superior wet grip performance and wear resistance while maintaining high elongation but exhibited lower setting resistance than that of Comparative Example 1.

On the other hand, Examples 6 and 7, which further contained a curing agent, exhibited even better wet grip performances, and wear resistances while maintaining high elongations, as well as even better setting resistances than that of Comparative Example 5.

### REFERENCE SIGNS LIST

1 Bead portion
2 Sidewall portion
3 Tire tread portion
4 Carcass layer
5 Bead core
6 Bead filler
7 Belt layer
8 Rim cushion

1. A rubber composition comprising:
a polymer containing from 10 to 90 mass % of a modified diene rubber having a carboxy group, and
an epoxy compound having a plurality of epoxy groups in each molecule;
a content of the epoxy compound being from 0.1 to 5 parts by mass per 100 parts by mass of the polymer.

2. The rubber composition according to claim 1, wherein a backbone of the modified diene rubber is at least one type selected from the group consisting of styrene butadiene rubbers, butadiene rubbers, and nitrile butadiene rubbers.

3. The rubber composition according to claim 1, wherein the modified diene rubber is produced by reacting a diene rubber as a raw material with a nitrone compound having a carboxy group and a nitrone group.

4. The rubber composition according to claim 3, wherein a degree of modification of double bonds into the carboxy groups contained in the nitrone compound relative to total amount of double bonds contained in the diene rubber as a raw material is from 0.02 to 4 mol %.

5. The rubber composition according to claim 3, wherein the nitrone compound is at least one type of carboxy group-containing nitrone compound selected from the group consisting of
N-phenyl-α-(4-carboxyphenyl)nitrone,
N-phenyl-α-(3-carboxyphenyl)nitrone,
N-phenyl-α-(2-carboxyphenyl)nitrone,
N-(4-carboxyphenyl)-α-phenylnitrone,
N-(3-carboxyphenyl)-α-phenylnitrone, and
N-(2-carboxyphenyl)-α-phenylnitrone.

6. The rubber composition according to claim 1, wherein a molecular weight of the epoxy compound is 3000 or less.

7. The rubber composition according to claim 1, further comprising a curing agent, the curing agent being an amine-based compound;
the amine-based compound having —NH₂ and at least one type of functional group selected from the group consisting of —NH₂, —NH—, and a carbon-nitrogen double bond, in each molecule.

8. The rubber composition according to claim 7, wherein a content of the curing agent is from 0.05 to 3.00 parts by mass per 100 parts by mass of the polymer.

9. The rubber composition according to claim 1, wherein the polymer further contains a diene rubber.

10. A pneumatic tire comprising the rubber composition described in claim 1.

11. A conveyor belt comprising the rubber composition described in claim 1.
